(19) United States
(12) Patent Application Publication
(10) Pub. No.: US 2024/0191822 A1
(43) Pub. Date: Jun. 13, 2024

(54) FLUID LINE CONNECTION ARRANGEMENT

(71) Applicant: HANON SYSTEMS EFP DEUTSCHLAND GMBH, Bad Homburg v.d. Höhe (DE)

(72) Inventors: Tilo Schäfer, Daubach (DE); Jan Hinrichs, Friedrichsdorf (DE); Michael Krug, Gau-Bischofsheim (DE)

(21) Appl. No.: 18/554,167

(22) PCT Filed: May 5, 2022
(86) PCT No.: PCT/DE2022/100346

§ 371 Date: Oct. 5, 2023

(30) Foreign Application Priority Data
Jun. 2, 2021 (DE) 10 2021 114 348.9
Dec. 20, 2021 (DE) 10 2021 133 850.6

(51) Int. Cl. F16L 41/03; B60K 11/02; B60L 58/24

(52) U.S. Cl. CPC F16L 41/03; B60K 11/02; B60L 58/24

(57) ABSTRACT

A fluid line connection arrangement which is adapted for use in a temperature control system of a battery electric driven vehicle. The fluid line connection arrangement has several fluid ports connected to one another via a fluid line network of fluidically communicating and/or fluidically not communicating fluid lines and to which fluid channels of the temperature control system can be connected for providing flow paths for a fluid, wherein the fluid lines of the fluid line network are held spaced apart by a holding structure such that an air gap is formed outside of the holding structure between adjacently arranged fluid lines.

### CROSS-REFERENCE TO RELATED PATENT APPLICATIONS

This patent application is a United States national phase patent application based on PCT/DE2022/100346 filed on May 5, 2022, which claims the benefit of German Patent Application No. 10 2021 133 850.6 filed on Dec. 20, 2021 and German Patent Application No. 10 2021 114 348.9 filed on Jun. 2, 2021, the entire disclosures of each of which are hereby incorporated herein by reference.

### TECHNICAL FIELD

The invention relates to a fluid line connection arrangement for use in a temperature control system of an electrically driven vehicle. The fluid line connection arrangement is adapted in particular for use in a temperature control system which has different fluid flows, for example for temperature control of the battery of a battery electric driven vehicle and for temperature control of the vehicle interior.

### BACKGROUND ART

In the case of battery electric driven vehicles, the lack of combustion heat requires efficient temperature control systems. In addition to the required efficiency, a technical challenge of temperature control systems for battery electric vehicles consists in ensuring the provision and handling of the fluid flows of different temperatures for the different temperature zones in the vehicle interior and for the temperature control of the on-board battery. Thus, fluid flows of different temperatures may be required to heat a vehicle interior on the one hand and to cool a battery or a battery system on the other hand. The technical implementation of such temperature control systems requires a plurality of components, such as pumps, sensors, valves, fluid line distributors, at least one compensating tank and in particular a fluid line network for handling the different fluid flows. A compact arrangement of these components is desired, but it has disadvantages. Thus, the compact arrangement of fluid lines, in particular in the fluid line distributor or in a fluid line connector, in which fluid flows of different temperatures come together in the pump region of the temperature control system and fluid channels are close to each other, leads to the problem of an undesirable heat transfer between the fluid circuits of different temperatures, which is at the expense of the efficiency of the entire temperature control system. For example, a fluid circuit, which is provided for cooling a battery temperature control, and a fluid circuit, which is provided for heating the vehicle interior, can come together in a fluid line distributor, which can be formed as a fluid line connector, as a result of which the fluid flows are influenced by a heat transfer. The risk of undesirable heat transfer therefore exists predominantly in the region of fluid distributor arrangements and compact fluid line connectors, as well as in the region of pumps of temperature control systems.

From U.S. Pat. No. 10,665,908 B2, a fluid line arrangement with integrated fluid channels is known, wherein coolant flows of different temperatures flow through the fluid channels arranged in a compact manner in a tank. As described above, this fluid line arrangement also has the problem of an undesirable heat transfer between fluid flows or fluid circuits of different temperatures due to the compact arrangement of the fluid lines.

### SUMMARY

The object of the invention is to provide a compact fluid line connection arrangement for a temperature control system of a battery electric driven vehicle, with which an undesirable heat transfer between fluid-carrying fluid lines in the region of the fluid line connection arrangement can be reduced.

The object is achieved by a fluid line connection arrangement having the features as shown and described herein.

The invention is based on the idea of providing a compact fluid line connection arrangement for a temperature control system of a battery electric driven vehicle, in which the fluid-carrying fluid lines are arranged in a compact manner in the smallest possible space and the risk of heat transfer between the fluid-carrying fluid lines is reduced in a simple manner by means of appropriately spaced apart arrangement.

The object is achieved with a fluid line connection arrangement which is adapted for use in a temperature control system of a battery electric driven vehicle. According to the invention, the fluid line connection arrangement has several fluid ports connected to one another via a fluid line network of fluidically communicating and fluidically not communicating fluid lines and to which fluid channels of the temperature control system can be connected for providing flow paths for a fluid. Further according to the invention, the fluid lines of the fluid line network are held spaced apart by a holding structure such that an air gap is formed outside of the holding structure between adjacently arranged fluid lines.

It has been found that an air gap of approximately one millimeter is sufficient to effectively reduce the heat transfer between fluid lines. The distances between the adjacently arranged fluid lines outside of the holding structure are therefore preferably at least 1 mm. Due to the design, this distance can be undershot in sections, particularly in the transition region to the holding structure.

Since the fluid lines of the fluid line network are held spaced apart by a holding structure, so that an air gap with air is formed as a comparatively bad heat conductor outside of the holding structure between adjacently arranged fluid lines, the heat transfer from adjacently arranged fluid-carrying fluid lines is reduced. This is made possible by a particularly filigree holding structure which has as few contact points as possible with a small contact surface on the fluid lines.

For a better understanding of the invention, the description distinguishes between fluid lines and fluid channels, wherein the fluid lines connect the fluid openings of the fluid line connection arrangement to one another, and wherein the fluid-carrying devices of the temperature control system are referred to as fluid channels which are connected to the fluid openings of the fluid line connection arrangement in order to provide a flow path for at least one fluid of the temperature control system.

The fluid line network has fluid lines which can be connected to one another in fluid communication. However, fluid lines can also be formed in the fluid line network which are not fluidically connected to further fluid lines of the fluid line network of the fluid line connection arrangement and consequently also do not communicate fluidically with the further fluid lines. These fluid lines, which do not communicate fluidically with further fluid lines of the fluid line connection arrangement, serve to directly connect fluid line channels of the temperature control system.

According to the literal sense, the fluid line connection arrangement serves to connect fluid channels or fluid circuits of the temperature control system of the battery electric driven vehicle. Accordingly, the fluid line network with its fluid lines is adapted to connect the fluid channels of different fluid circuits of the temperature control system independently of one another or to join them by means of fluidically communicating fluid lines. The fluid line network can further have fluid lines branching in a flow direction, so that a fluid flow can be distributed into several fluid flows onto several fluid lines. Thus, the fluid line connection arrangement can advantageously also perform the function of a fluid line distributor. In this case, the term fluid flow distributor also applies since a fluid flow can be distributed with branching fluid channels.

According to an advantageous development of the invention, the fluid line connection arrangement has at least one fluidic interface for the fluidic connection of at least one further component of the temperature control system to at least one fluid line of the fluid line network. The further component can be a valve, a volute of a pump and/or a fluid reservoir.

The fluid reservoir can be held and arranged by the holding structure such that an air gap is formed outside of the holding structure between the fluid reservoir and fluid lines of the fluid line network which are not directly fluidically connected to the fluid reservoir. Because of the spaced apart arrangement between the fluid reservoir and fluid lines of the fluid line network which are not directly fluidically connected to the fluid reservoir, the risk of heat transfer between the fluid reservoir and the fluid lines of the fluid line network which are not directly fluidically connected to the fluid reservoir is reduced, in particular because of the air arranged between them as a bad heat conductor. According to an advantageous embodiment of the fluid line connection arrangement according to the invention, the fluid reservoir can be formed as an integral part of the fluid line connection arrangement.

Further, it can be provided that the holding structure is formed on the fluid reservoir, so that the fluid lines of the fluid line network are arranged held spaced apart on the fluid reservoir. In this case, the fluid reservoir, in particular the outer shell of the fluid reservoir, can be formed as a part of the holding structure.

According to a further embodiment of the fluid line connection arrangement according to the invention, the fluid line network can have a plenum into which several of the fluid lines end. The plenum can have a fluidic interface for the fluidic connection to the volute of a pump. The plenum serves to combine fluid flows which have a similar temperature. Starting from the plenum, the fluid contained therein can pass into the volute of a pump of the temperature control system for further delivery via the fluidic interface.

Furthermore, it can be provided that the plenum is formed as an integral structure of the holding structure of the fluid line connection arrangement according to the invention. In this case, elements of the holding structure which impart their stability to the fluid line connection arrangement form a plenum. In this embodiment, the plenum is formed from the material of the holding structure.

The fluid line network with its fluid-carrying fluid lines and the holding structure are preferably formed from a badly heat-conducting material, preferably from a plastic.

Polypropylene (PP) is employed as the preferred material. However, polyamide-based materials are also conceivable, such as PA6 and PA66, or a polyketone (PK). The plastic employed can have a glass fiber content in the range from 10% to 30%. The use of glass fibers reinforces the plastic and thus the structure of the fluid line connection arrangement.

According to a particularly advantageous embodiment of the fluid line connection arrangement according to the invention, the holding structure, the plenum, the fluid reservoir and the fluid line network with its fluid lines can be produced as an integral injection-molded part. The integral embodiment is particularly advantageous because the entire fluid line connection arrangement, as an injection-molded part, permits simplified assembly in the temperature control system.

Furthermore, it can be provided that the holding structure, the plenum, the fluid reservoir and the fluid line network with its fluid lines are formed by injection-molded parts produced in the injection-molding process and subsequently joined or plugged together. For fluid-tight connection, the injection-molded parts can be connected to one another by means of a joining process, for example welding, or by means of a plug connection. The use of injection-molded parts has the advantage that the holding structure and the fluid reservoir and the fluid line network with its fluid lines from the badly heat-conducting material are already formed in the injection-molding process, so that subsequent assembly is eliminated or simplified.

The holding structure is preferably formed from ribs and/or ridges, wherein the ribs and/or the ridges are arranged at least in regions between the fluid lines of the fluid line network for stabilization and as spacers. The ribs and/or the ridges, which extend along the fluid lines, serve as stabilizing stiffening elements of the holding structure. Advantageously, the holding structure can be formed at least in regions in the form of a honeycomb structure, wherein the fluid lines form the corner points of the honeycomb structure.

According to a still further embodiment of the fluid line connection arrangement according to the invention, it can be provided that the fluid lines, which are provided for guiding fluid flows with substantially the same temperature, are arranged spatially combined with the holding structure. In this way, the risk of heat transfers between fluid lines which guide fluid flows at substantially different temperatures is further reduced. Furthermore, it can be provided that fluid lines which guide fluid flows of substantially different temperatures are arranged spatially separated from one another by means of the holding structure. Spatial separation can be implemented, for example, in that fluid lines which guide fluid flows of different temperatures are arranged at opposite ends of the fluid line connection arrangement or are formed on different sides of a fluid reservoir. Thus, on a first side or a first outer wall of a fluid reservoir fluid lines can be arranged spaced apart with the holding structure, which guide a fluid at a high temperature, wherein fluid lines which guide a fluid at a lower temperature can be arranged held spaced apart by the holding structure at a second side or a second outer wall of the fluid reservoir opposite the first side or the first outer wall of the fluid reservoir.

Further advantages of the invention are set forth below:

The invention enables a compact arrangement of the fluid line connection arrangement within a temperature control system of an electrically driven vehicle. In particular the integral design as an injection-molded plastic part makes it possible to reduce the number of parts and simplifies assembly as a unit within the temperature control system. The reduction of the heat transfer between the fluid-carrying fluid lines within the temperature control system, in particular at the interface between components of the temperature control system, has a positive influence on the efficiency of the temperature control system of an electrically driven vehicle. For cooling and heating, therefore, overall less electrical energy is required since undesirable heat transfers are reduced. This has a positive influence on the range of the battery electric driven vehicle. The reduction of the installation space required for the temperature control system also has a positive influence on the construction of the battery electric driven vehicle since, on the one hand, more installation space is available for other components of the vehicle or the space available for occupants can be increased.

### DESCRIPTION OF DRAWINGS

Further details, features, and advantages of embodiments of the invention will become apparent from the following description of exemplary embodiments with reference to the accompanying drawings. In the figures:

FIG. 1: shows a schematic representation of an exemplary embodiment of the fluid line connection arrangement in a first view,

FIG. 2: shows a schematic representation of an exemplary embodiment of the fluid line connection arrangement in a top view,

FIG. 3: shows a sectional representation of the exemplary embodiment of the fluid line connection arrangement shown in FIG. 2,

FIG. 4: shows a further view of the exemplary embodiment of the fluid line connection arrangement shown in FIG. 2,

FIG. 5: shows a schematic representation of a further exemplary embodiment of the fluid line connection arrangement according to the invention; and

FIG. 6: shows a perspective representation of an exemplary embodiment of the fluid line connection arrangement according to the invention.

### DETAILED DESCRIPTION OF EMBODIMENTS

Recurring features are indicated with the same reference numerals in the figures.

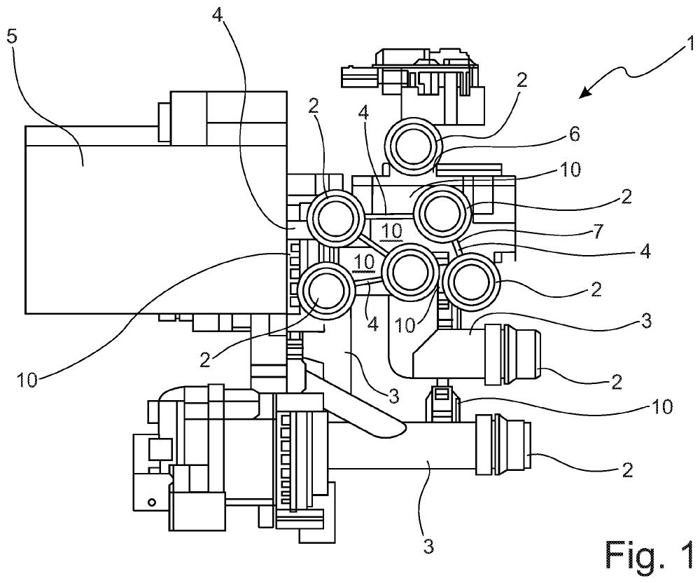

FIG. 1 shows a schematic representation of an exemplary embodiment of the fluid line connection arrangement 1 according to the invention, which is provided for use in a temperature control system of an electrically driven vehicle. The fluid line connection arrangement 1 has fluid ports 2 which are connected to one another via a fluid network of fluidically communicating and fluidically not communicating fluid lines 3. The fluid line connection arrangement 1 with fluid channels of a temperature control system not shown in FIG. 1 for providing flow paths for a fluid, for example a coolant, can be connected to the fluid ports 2. The fluid lines 3 of the fluid line network are held spaced apart by a holding structure 4 such that an air gap 10 is formed outside of the holding structure 4 between adjacently arranged fluid lines 3. The reference numeral 5 designates a fluid reservoir which is connected to the holding structure 4 such that an air gap 10 is formed outside of the holding structure 4 between the fluid reservoir 5 and fluid lines 3 of the fluid line network not directly fluidically connected to the fluid reservoir 5. In the example shown, the fluid reservoir 5 is formed as a separate component which has an interface for the fluidic connection to at least one fluid line 3 of the fluid line network. According to an embodiment of the fluid line connection arrangement 1 according to the invention, the fluid reservoir 5 can be formed as an integral part of the holding structure 4. The fluid reservoir 5 thereby forms a part of the holding structure 4 or parts of the holding structure 4, such as stabilizing ribs 6 or ridges 7, emerge from the material of the fluid reservoir 5.

The holding structure 4 forms ribs 6 and ridges 7 between the adjacently arranged fluid lines 3, whereby the fluid lines 3 are spaced apart and are stabilized in the arrangement. Several of the ridges 7 are formed between the fluid lines 3 and are connected to the fluid lines 3 at a position on the outer circumference of the fluid lines 3.

In the example shown, the holding structure 4 and the fluid line network with its fluid lines 3 are produced as an integral injection-molded part from a plastic. The plastic is a thermoplastic material which has low thermal conduction properties. The webs 7 formed by the holding structure 4 between the adjacently arranged fluid lines 3 create a filigree, honeycomb-like and/or grid-like structure which imparts stability to the arrangement of the fluid lines 3 without a large contact surface being required for the ribs 6 or ridges 7 of the holding structure 4 on the outer surface of adjacently arranged fluid lines 3. In this way, comparatively large free surfaces are provided between the adjacently arranged fluid lines 3 on the outer surface of the fluid lines 3, between which air is located as a badly heat-conducting medium. Advantageously, the fluid reservoir is also formed from the thermoplastic material.

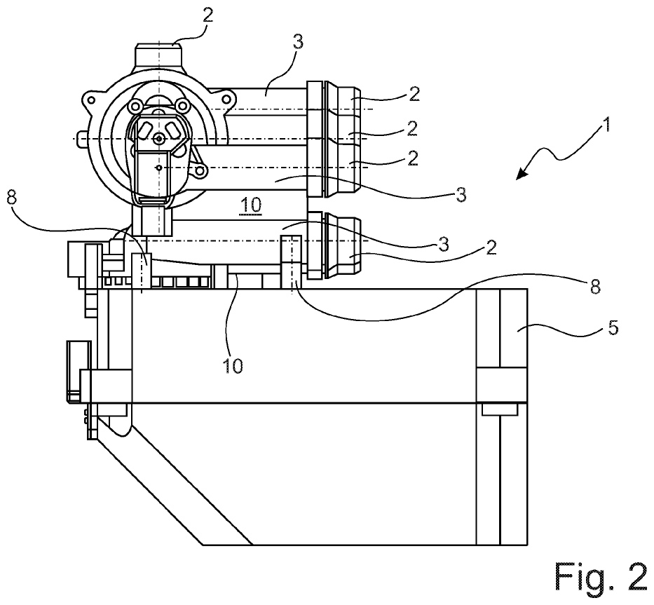

FIG. 2 shows a top view of the exemplary embodiment of the fluid line connection arrangement 1 shown in FIG. 1. The top view shows adjacent fluid lines 3 arranged in parallel and the fluid ports 2, to which fluid channels of the temperature control system can be connected in order to provide flow paths for a fluid. The fluid reservoir 5 has a fluidic interface for the fluidic connection to a fluid line 3 (interface not shown). The holding structure 4 formed integrally between the fluid lines 3 extends along the outer wall 9 of the fluid reservoir 5 with receptacles 8 of the holding structure 4. The receptacles 8 of the holding structure 4 are formed as spacers between the outer wall 9 of the fluid reservoir 5 and the oppositely arranged fluid line 3, so that an air gap 10 is formed between the directly oppositely arranged fluid line 3 and the outer wall 9 of the fluid reservoir 5.

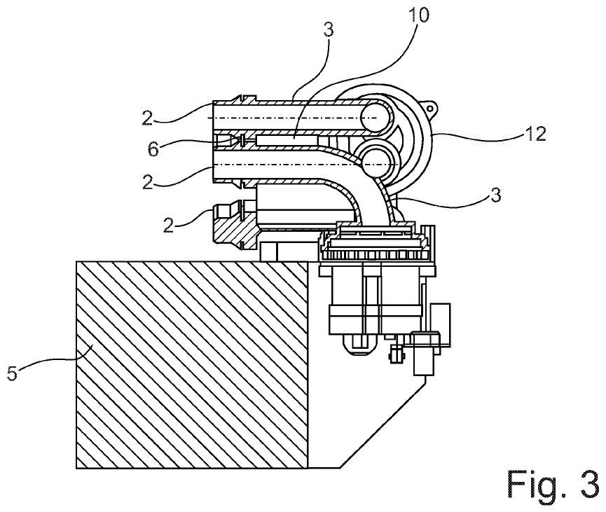

FIG. 3 shows a sectional representation of the exemplary embodiment of the fluid line connection arrangement 1 shown in FIG. 2 with two fluid lines 3 which form a common intake region of the pump 12 shown. The fluid reservoir 5 is also represented in section. An air gap 10 is formed between the fluid lines 3 at least in regions. The air gap 10 prevents a direct heat transfer between the fluid lines 3.

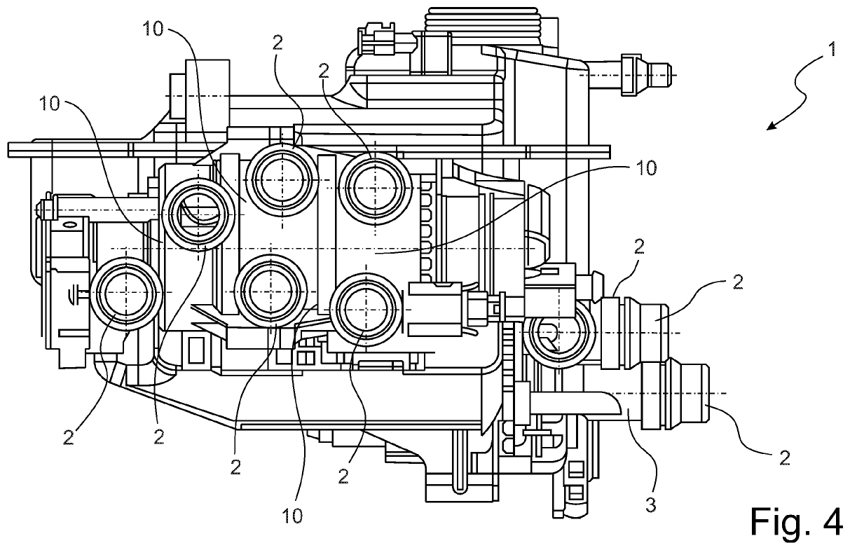

FIG. 4 shows a further view of the exemplary embodiment of the fluid line connection arrangement 1 shown in FIG. 2 and in FIG. 3 with a compact arrangement of the fluid lines 3. In the exemplary embodiment shown, six fluid ports 2 are shown from above, wherein a view into the fluid lines 3 is made possible. The fluid lines 3 are each arranged such that an air gap 10 is formed between them at least in regions.

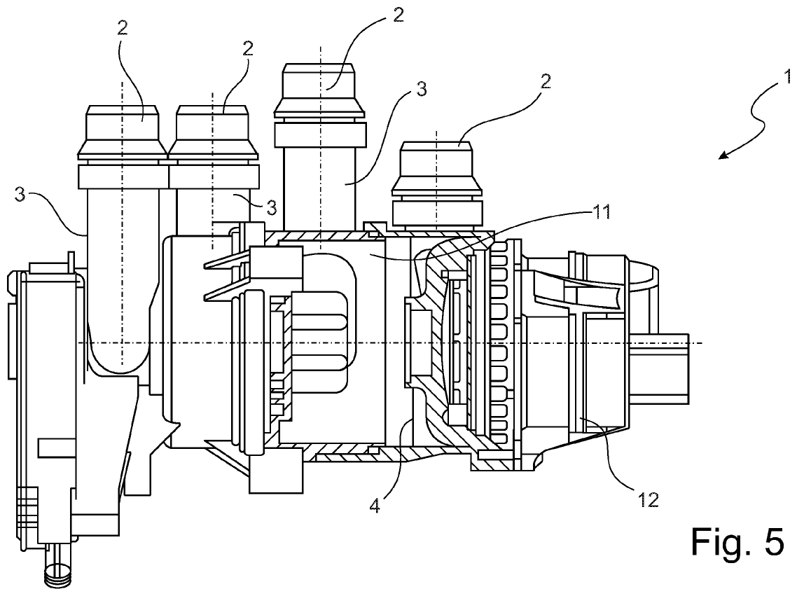

FIG. 5 shows a top view of the fluid line connection arrangement 1, wherein a plenum 11, which is formed as an integral structure of the holding structure 4, is formed between the fluid line connection arrangement 1 and the pump 12 such that fluid flows of fluid lines 3 (not shown) ending in the plenum 11 can be collected in the plenum 11 and supplied together to the pump 12.

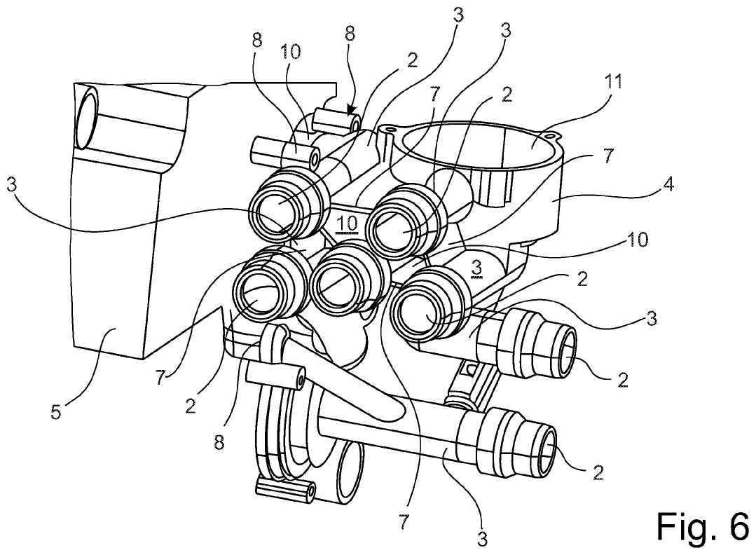

FIG. 6 shows a perspective representation of an exemplary embodiment of the fluid line connection arrangement 1 according to the invention, with fluid ports 2 which are connected to one another via fluid lines 3, wherein a holding structure 4 formed from ridges 7 is formed between adjacently arranged fluid lines 3, which makes it possible for an air gap 10 to be formed in regions between the fluid lines 3. The ridges 7 and the fluid lines 3 are integrally produced from the same material as an injection-molded plastic part. On the receptacles 8 of the holding structure 4, a fluid reservoir 5 is arranged spaced apart from the fluid lines 3 such that an air gap 10 is formed between the fluid reservoir 5 and the fluid lines 3. The fluid reservoir 5 has a fluidic interface for the fluidic connection to the fluid line structure of the fluid line network. The plenum 11 is also formed from the material of the holding structure 4 as an integral part of the holding structure 4.

### LIST OF REFERENCE NUMERALS

1 fluid line connection arrangement
2 fluid ports
3 fluid lines
4 holding structure
5 fluid reservoir
6 ribs
7 ridges
8 receptacles
9 outer wall of fluid reservoir
10 air gap
11 plenum
12 pump

1-13. (canceled)

14. A fluid line connection arrangement which is adapted for use in a temperature control system of a battery electric driven vehicle, wherein the fluid line connection arrangement comprises a plurality of fluid ports connected to one another via a fluid line network of fluidically communicating and/or fluidically not communicating fluid lines and to which fluid channels of the temperature control system can be connected for providing flow paths for a fluid, wherein the fluid lines of the fluid line network are held spaced apart by a holding structure such that an air gap is formed outside of the holding structure between adjacently arranged ones of the fluid lines.

15. The fluid line connection arrangement according to claim 14, further comprising at least one fluidic interface for fluidic connection of at least one further component of the temperature control system to at least one of the fluid lines of the fluid line network, wherein the at least one further component is a valve, a volute of a pump and/or a fluid reservoir.

16. The fluid line connection arrangement according to claim 15, wherein the at least one further component is the fluid reservoir held by the holding structure and arranged such that the air gap is formed outside of the holding structure between the fluid reservoir and the fluid lines of the fluid line network which are not directly fluidically connected to the fluid reservoir.

17. The fluid line connection arrangement according to claim 14, wherein the fluid line network has a plenum in which several of the fluid lines end, wherein the plenum has a fluidic interface for fluidic connection to a volute of a pump.

18. The fluid line connection arrangement according to claim 17, wherein the plenum is formed as an integral structure of the holding structure.

19. The fluid line connection arrangement according to claim 14, wherein the fluid line network and the holding structure are formed from a plastic.

20. The fluid line connection arrangement according to claim 19, wherein the plastic has a glass fiber content in a range from 10% to 30%.

21. The fluid line connection arrangement according to claim 15, wherein the at least one further component is the fluid reservoir and wherein the holding structure, the fluid reservoir and the fluid line network with the fluid lines are produced as an integral injection-molded part.

22. The fluid line connection arrangement according to claim 15, wherein the at least one further component is the fluid reservoir and wherein the holding structure, the fluid reservoir and the fluid line network with the fluid lines are formed by injection-molded parts produced, joined or plugged together in an injection-molding process.

23. The fluid line connection arrangement according to claim 14, wherein the holding structure is formed from ribs and/or ridges, wherein the ribs and/or the ridges are arranged in regions between the fluid lines of the fluid line network for stabilization and as spacers.

24. The fluid line connection arrangement according to claim 14, wherein the fluid lines which are provided for guiding fluid flows at substantially a same temperature are arranged spatially combined by means of the holding structure.

25. The fluid line connection arrangement according to claim 14, wherein the fluid lines which carry fluid flows with substantially different temperatures are arranged spatially separated by means of the holding structure.

26. The fluid line connection arrangement according to claim 14, wherein on a first side or a first outer wall of a fluid reservoir, the fluid lines are arranged spaced apart with the holding structure and which guide a fluid with a comparative higher temperature, wherein the fluid lines which guide a fluid with a comparative lower temperature are arranged on a second side or a second outer wall of the fluid reservoir opposite to the first side or the first outer wall of the fluid reservoir held spaced apart by the holding structure.
